(19) United States
(12) Patent Application Publication
(10) Pub. No.: US 2013/0107851 A1
(43) Pub. Date: May 2, 2013

(54) METHOD AND DEVICE FOR PERFORMING TERMINAL COOPERATIVE TRANSMISSION IN WIRELESS ACCESS SYSTEM

(71) Applicants: Kyujin Park, Anyang (KR); Hangyu Cho, Anyang (KR); Dongguk Lim, Anyang (KR); Seunghyun Kang, Anyang (KR)

(72) Inventors: Kyujin Park, Anyang (KR); Hangyu Cho, Anyang (KR); Dongguk Lim, Anyang (KR); Seunghyun Kang, Anyang (KR)

(73) Assignee: LG ELECTRONICS INC., Seoul (KR)

(21) Appl. No.: 13/809,853

(22) PCT Filed: Jul. 12, 2011
(86) PCT No.: PCT/KR2011/005117

§ 371 Date: Jan. 11, 2013

Related U.S. Application Data
(60) Provisional application No. 61/363,652, filed on Jul. 13, 2010.

(51) Int. Cl. H04W 72/04

(52) U.S. Cl. CPC H04W 72/0413
USPC 370/329

(57) ABSTRACT

The present invention relates to a method for performing terminal cooperative transmission through direct link communication between a source terminal that requests terminal cooperation and a cooperative terminal that performs the terminal cooperative transmission with the source terminal in a wireless access system, and the method comprises the steps of allowing the source terminal to transmit a terminal cooperation request message for requesting the terminal cooperative transmission to a base station, allowing the base station to transmit control information for establishing a direct link between the source terminal and the cooperative terminal to the source terminal, and allowing the source terminal to establish a direct communication link with the cooperative terminal, on the basis of the received control information, wherein the control information contains dedicated random access channel (RACH) allocation information for synchronization between the source terminal and the cooperative terminal and for channel measurement, and dedicated random access channel (RACH) preamble sequence information.

### TECHNICAL FIELD

The present invention relates to mobile station cooperative transmission, and more particularly to a method and device for performing mobile station cooperative transmission through a direct link communication between mobile stations.

### BACKGROUND ART

In the existing wireless mobile communication system, data transmission has been performed using a radio link only between a base station and a mobile station, or between a relay node and a mobile station. However, a method for cooperative communication between mobile stations has been recently developed for the purpose of throughput enhancement, power consumption reduction of a mobile station, cell coverage extension, etc. Also, direct communication through configuration of a direct link between mobile stations without through a base station has been considered as a method for increasing efficiency of wireless communication.

In this respect, a method for configuring a direct link between mobile stations to achieve cooperative communication or direct communication between mobile stations will be required.

### DISCLOSURE

### Technical Problem

Accordingly, an object of the present invention devised to solve the conventional problem is to provide a method for configuring a direct communication link between mobile stations to achieve cooperative communication between mobile stations.

Specifically, in this specification, if UL subframe set by a base station is used for data link transmission and reception between a source mobile station and a cooperative mobile station, another object of the present invention is to provide a method for synchronization between the mobile stations, a method for performing channel measurement between the mobile stations, and HARQ ACK/NACK feedback methods of the cooperative mobile station.

In this case, although the present invention is described on the basis of a 3GPP LTE/LTE-A system, it will be apparent that the same concept may be applied to an IEEE 802.16 based system.

### Technical Solution

To solve the aforementioned technical problems, according to one embodiment of the present invention, a method for performing mobile station cooperative transmission through direct link communication between a source mobile station requesting mobile station cooperation and a cooperative mobile station performing mobile station cooperative transmission comprises the steps of allowing the source mobile station to transmit a mobile station cooperation request message for requesting the mobile station cooperative transmission to a base station; allowing the base station to transmit control information for configuring a direct link between the source mobile station and the cooperative mobile station to the source mobile station; and allowing the source mobile station to configure a direct communication link with the cooperative mobile station on the basis of the received control information, wherein the control information includes dedicated random access channel (RACH) allocation information for synchronization and channel measurement between the source mobile station and the cooperative mobile station, and dedicated random access channel (RACH) preamble sequence information.

Also, the step of configuring a direct communication link includes the steps of allowing the base station to transmit the dedicated RACH preamble sequence information, which is transmitted to the source mobile station, to at least one candidate cooperative mobile station; allowing the source mobile station to transmit the dedicated RACH preamble sequence information to the at least one candidate cooperative mobile station through a dedicated random access channel allocated from the base station; and allowing the at least one candidate cooperative mobile station to feed a timing advance (TA) value and a channel measured value for a direct link with the source mobile station back to the base station on the basis of the dedicated random access channel preamble sequence information received from the source mobile station.

Also, the at least one candidate cooperative mobile station feeds a channel measured value for a full band, per sub-band, or for a specific sub-band back to the base station, if the channel measured value is greater than a threshold value which is previously defined.

Also, in this specification, the method further comprises the steps of allowing the base station to set at least one cooperative mobile station for performing cooperative transmission with the source mobile station on the basis of the feedback channel measured value and the timing advance value of the at least one candidate cooperative mobile station; and allowing the base station to transmit information on the set cooperative mobile station to the source mobile station and the set cooperative mobile station.

Also, in this specification, the method further comprises the step of allowing the source mobile station to transmit and receive data to and from the cooperative mobile station through an uplink (UL) subframe defined for direct link communication between the source mobile station and the cooperative mobile station.

Also, the step of allowing the source mobile station to transmit and receive data to and from the cooperative mobile station includes transmitting data to the cooperative mobile station through a first direct link UL subframe, and allowing the cooperative mobile station to transmit ACK/NACK for the data received from the source mobile station, to the source mobile station through a second direct link UL subframe.

Also, the method further comprises the step of allowing the base station to transmit information indicating timing relation between the first direct link UL subframe and the second direct link UL subframe to at least one of the source mobile station and the cooperative mobile station.

Also, at least one symbol at the front and/or the rear of the uplink subframe is used as a transition gap of a transmission and reception mode.

Also, the transition gap is set variably depending on a timing advance (TA) value based on a distance between the source mobile station and the cooperative mobile station.

Also, the control information further includes timing information on transmission timing of the dedicated RACH preamble sequence, the timing information being expressed as a subframe offset value or a subframe index value.

Also, in this specification, the method further comprises the step of allowing the at least one candidate cooperative mobile station to receive uplink (UL) grant for feeding back the channel measured value and the timing advance (TA) value from the base station.

Also, the UL grant is received from the base station after a predetermined subframe on the basis of the dedicated RACH preamble sequence transmission timing.

In another aspect of the present invention, a mobile station for performing mobile station cooperative transmission through direct link communication with a source mobile station in a wireless access system comprises a radio frequency (RF) unit for externally transmitting and receiving a radio signal; and a controller connected with the RF unit, wherein the controller controls the RF unit to transmit a mobile station cooperation request message for requesting the mobile station cooperative transmission to a base station, controls the RF unit to receive control information for configuring a direct link with the cooperative mobile station from the base station, and controls the RF unit to configure the direct communication link with the cooperative mobile station on the basis of the received control information, and the control information includes dedicated random access channel (RACH) allocation information for synchronization and channel measurement between the source mobile station and the cooperative mobile station, and dedicated random access channel (RACH) preamble sequence information.

### Advantageous Effects

According to the present invention, as a method for configuring a direct communication link between a source mobile station and a cooperative mobile station to perform cooperative communication between the mobile stations and HARQ ACK/NACK feedback method of the cooperative mobile station are provided, throughput for data transmission of the mobile station may be increased, power consumption of the mobile station may be reduced, and cell coverage may be extended.

### BRIEF DESCRIPTION OF THE DRAWINGS

FIG. 1 is a conceptional diagram illustrating a wireless communication system to which an embodiment of the present invention may be applied;

FIG. 2 is an inner block diagram illustrating a mobile station and a base station in a wireless access system to which an embodiment of the present invention may be applied;

FIGS. 3(a) and 3(b) are diagrams illustrating a concept of mobile station cooperative transmission to which an embodiment of the present invention may be applied;

FIG. 4 is a diagram illustrating a concept of a cooperative cluster of mobile stations to which an embodiment of the present invention may be applied;

FIG. 5 is a diagram illustrating an example of a system that performs client cooperation (CC) between mobile stations in a wireless communication environment where two or more heterogeneous networks (multi-RAT), to which an embodiment of the present invention may be applied, exist;

FIGS. 6(a) and 6(b) are flow charts illustrating a method for allocating a dedicated random access channel resource for direct link communication between mobile stations according to one embodiment of the present invention;

FIGS. 7(a) and 7(b) are diagrams illustrating a structure of a subframe for direct link communication between cooperative mobile stations according to one embodiment of the present invention; and

FIG. 8 is a flow chart illustrating a HARQ feedback procedure of a cooperative mobile station in direct link communication for mobile station cooperative transmission according to one embodiment of the present invention.

### BEST MODE FOR CARRYING OUT THE INVENTION

The following technology may be used for various wireless access systems such as code division multiple access (CDMA), frequency division multiple access (FDMA), time division multiplex access (TDMA), orthogonal frequency division multiple access (OFDMA), and single carrier frequency division multiple access (SC-FDMA). The CDMA may be implemented by the radio technology such as universal terrestrial radio access (UTRA) or CDMA2000. The TDMA may be implemented by the radio technology such as global system for mobile communications (GSM)/general packet radio service (GPRS)/enhanced data rates for GSM evolution (EDGE). The OFDMA may be implemented by radio technology such as IEEE 802.11 (Wi-Fi), IEEE 802.16 (WiMAX), IEEE 802.20, and evolved UTRA (E-UTRA). IEEE 802.16m is an evolved version of IEEE 802.16e, and provides backward compatibility with IEEE 802.16e based system.

The UTRA is a part of a universal mobile telecommunications system (UMTS). A 3rd generation partnership project long term evolution (3GPP LTE) communication system is a part of an evolved UMTS (E-UMTS) that uses E-UTRA, and uses OFDMA on a downlink and SC-FDMA on an uplink. LTE-advanced (LTE-A) is an evolved version of the 3GPP LTE.

It is to be understood that technical terms used in this specification are used to describe a specific embodiment and are not indeed to restrict the present invention. Also, it is to be understood that the technical terms used in this specification should generally be understood by the person with ordinary skill in the art to which the present invention pertains unless defined separately, and should not be defined to refer to too comprehensive or reduced meaning. Also, when the technical terms used in this specification fail to exactly express the technical spirits of the present invention, the terms should be replaced with those that may be understood by the person with ordinary skill in the art. Also, general terms used in the present invention should be defined in accordance with the context as defined in a dictionary and should not be defined to refer to too reduced meaning.

Also, the singular expression used in this specification includes the plural expression unless meant differently on the context. In this application, it is to be understood that the terms such as “comprise” and “include” should not be defined to essentially include all of various elements or various steps disclosed in this specification and should be defined to include some of the elements or steps or further include additional elements or steps.

Also, although the terms indicating the ordinal number such as first and second may be used to describe various elements, the elements should not be restricted by the terms. The terms are used to identify one element from another element. For example, the first element may be referred to as the second element and vice versa within the scope of the present invention.

The expression “an element is connected with another element” means that an element may directly be connected with another element or still another element may exist therebetween. On the other hand, the expression “an element is directly connected with another element” means that no still another element exists therebetween.

Reference will now be made in detail to the preferred embodiments of the present invention, examples of which are illustrated in the accompanying drawings. Wherever possible, the same reference numbers will be used throughout the drawings to refer to the same or like parts. In the description of the present invention, detailed description of the related art, which may make the subject matter of the present invention obscure, will be omitted. Also, it is to be understood that the accompanying drawings are intended to easily understand technical spirits of the present invention and the technical spirits of the present invention should not be limited by the accompanying drawings. It is to be understood that the technical spirits of the present invention may be extended to all modifications, equivalents or replacements in addition to the drawings.

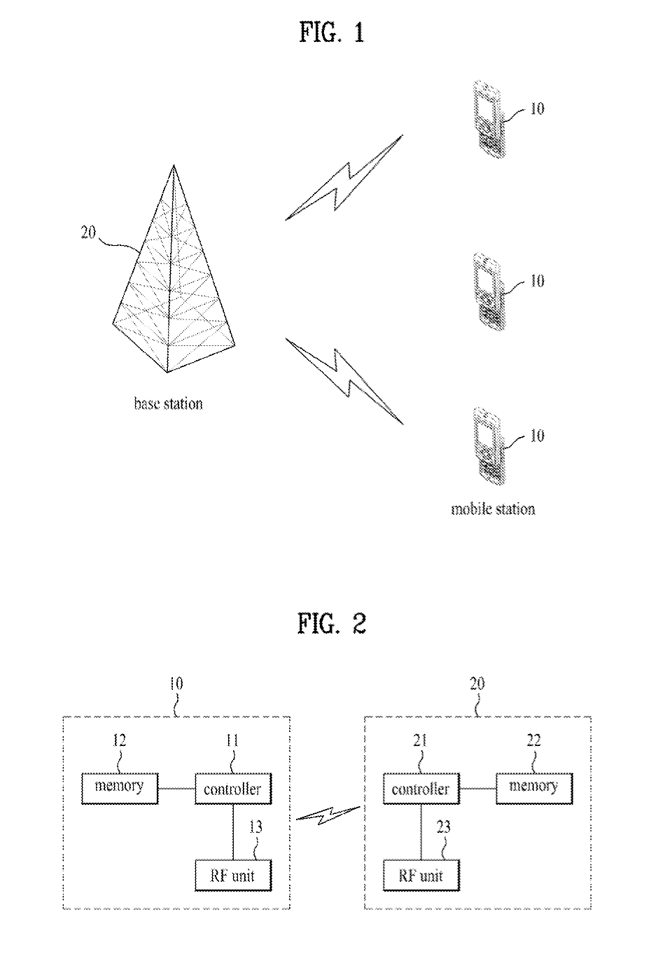

FIG. 1 is a conceptional diagram illustrating a wireless communication system to which an embodiment of the present invention may be applied. The wireless communication system is widely arranged to provide various communication services such as voice and packet data.

Referring to FIG. 1, the wireless communication system includes a mobile station 10 (MS) and a base station 20 (BS). The mobile station 10 may be fixed or may have mobility, and may be referred to as other terms such as a user equipment (UE), a user terminal (UT), a subscriber station (SS), a wireless device and an advanced mobile station (AMS).

Also, if the wireless communication system shown in FIG. 1 supports a mobile station cooperative communication (or transmission), the mobile station 10 includes a concept of a cooperative request mobile station that requests mobile station cooperation, a cooperative grant mobile station that grants mobile station cooperation, or a cooperative join mobile station that joins in mobile station cooperation.

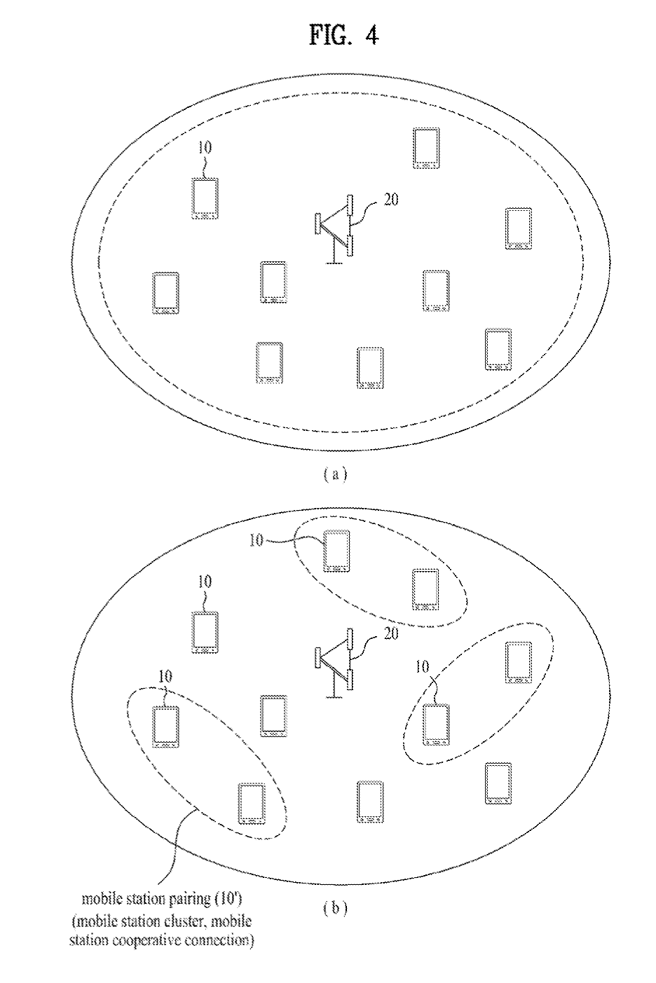

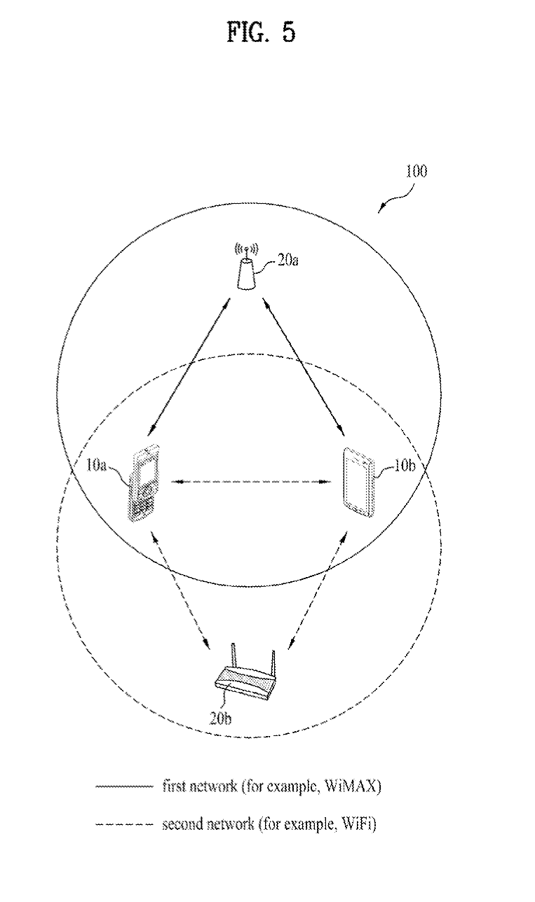

Mobile station cooperative communication will be described in more detail with reference to FIG. 3 and FIG. 4.

The base station 20 generally means a fixed station that performs communication with the mobile station 10, and may be referred to other terms such as a node B, a base transceiver system (BTS), and an access point (AP). One or more cells may exist in one base station 20.

The wireless communication system may be an orthogonal frequency division multiplexing/orthogonal frequency division multiple access (OFDM/OFDMA) based system.

The OFDM uses a plurality of orthogonal subcarriers. The OFDM uses orthogonality between inverse fast fourier transform (IFFT) and fast fourier transform (FFT). A transmitter transmits data by performing IFFT for the data. A receiver recovers the original data by performing FFT for the received signal. The transmitter uses IFFT to combine multiple subcarriers, while the transmitter uses FFT to split the multiple subcarriers.

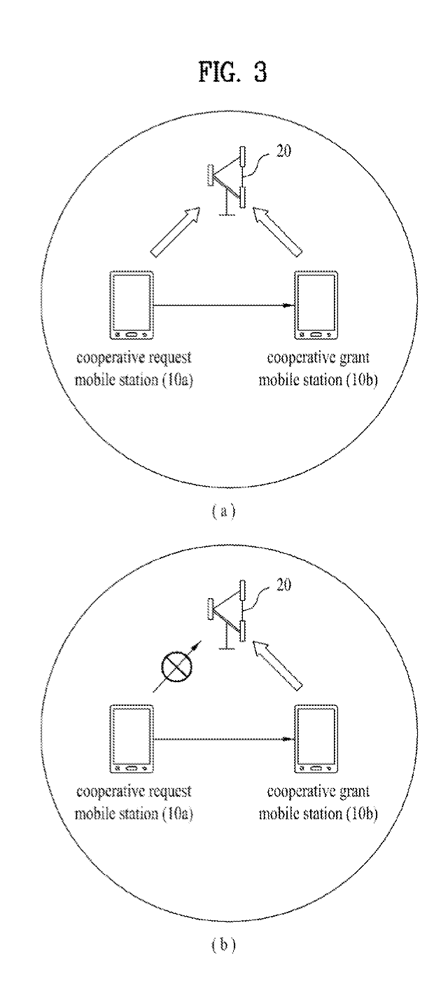

FIG. 2 is an inner block diagram illustrating a mobile station and a base station in a wireless access system to which an embodiment of the present invention may be applied.

The mobile station 10 includes a controller 11, a memory 12, and a radio frequency (RF) unit 13.

Also, the mobile station 10 includes a display unit and a user interface unit.

The controller 11 performs functions, procedures and/or methods as suggested. Radio interface protocol layers may be implemented by the controller 11.

The memory 12 is connected with the controller 11, and stores protocols or parameters for performing radio communication. In other words, the memory 12 stores mobile station driving system, applications and general files.

The RF unit 13 is connected with the controller 11, and transmits and/or receives a radio signal.

Additionally, the display unit displays various kinds of information of the mobile station. Well known elements such as a liquid crystal display (LCD) and organic light emitting diodes (OLED) may be used as the display unit. The user interface unit may be comprised of combination of well known user interfaces such as a key pad or a touch screen.

The base station 20 includes a controller 21, a memory 22, and a radio frequency (RF) unit 23.

The controller 21 performs functions, procedures and/or methods as suggested. Radio interface protocol layers may be implemented by the controller 21.

The memory 22 is connected with the controller 21, and stores protocols or parameters for performing radio communication.

The RF unit 23 is connected with the controller 21, and transmits and/or receives a radio signal.

The controller 11 or 21 may include an application-specific integrated circuit (ASIC), different chip sets, a logical circuit, and/or a data processing device. The memory 12 or 22 may include a read-only memory (ROM), a random access memory (RAM), a flash memory, a memory card, a storage medium, and/or other storage unit. The RF unit 13 or 23 may include a baseband circuit for processing a radio signal. When the embodiment is implemented by software, the aforementioned method may be implemented by module (procedure, function, etc.) for performing the aforementioned functions. The module is stored in the memory 12 or 22 and may be implemented by the controller 11 or 21.

The memory 12 or 22 may be located inside or outside the controller 11 or 21, and may be connected with the controller 11 or 21 by a well known means.

FIGS. 3(a) and 3(b) are diagrams illustrating a concept of mobile station cooperative transmission to which an embodiment of the present invention may be applied.

As will be aware of it from FIG. 3, the base station 20 and the mobile stations are provided. In this case, the mobile station 10a may request cooperation with another mobile station 10b due to the reason such as poor channel status or insufficient resource allocation, and the mobile station 10b may transmit data of the mobile station 10a to the base station 20 in response to the cooperation request.

A random mobile station may request the base station to support a client cooperation technique such as mobile relaying or cooperative transmission for the purpose of throughput enhancement or power consumption reduction. Alternatively, the base station may request a specific mobile station of client cooperation for the same purpose.

In this way, if client cooperation is performed, a mobile station that generates data to be transmitted to the base station in case of an uplink and a mobile station that should finally receive data from the base station in case of a downlink will be referred to as source mobile stations, and a mobile station that assists data transmission and reception to and from the base station will be referred to as a cooperative mobile station.

Also, mobile stations that may perform cooperative communication for a given source mobile station will be referred to as candidate cooperative mobile stations, and one of the candidate cooperative mobile stations is selected as a cooperative mobile station for cooperative communication by the base station or the source mobile station. Likewise, in two mobile stations that perform direct communication without through a base station, the mobile station that performs data transmission will be referred to as a source mobile station, and the mobile station that receives corresponding data through a data link between the mobile stations will be referred to as a cooperative mobile station.

However, the two mobile stations that perform direct communication may act as source mobile stations at the time when they transmit data dynamically, and may act as cooperative mobile stations at the time when they receive data.

At this time, as shown in FIG. 3, the mobile station that requests the cooperation has been referred to as the cooperative request mobile station, and the mobile station that responds to the cooperation has been referred to as the cooperative mobile station.

The cooperative request mobile station may also be referred to a cooperative entity mobile station or a source mobile station. The cooperative mobile station may also be referred to as a cooperative transmission mobile station or a cooperated mobile station.

Also, in FIG. 3, the number of cooperative mobile stations 10b that transmit data of the mobile station 10a in response to the cooperation is 1. In this way, if the number of cooperative mobile stations 10b is limited to 1, processing delay may be reduced and cooperative communication may be implemented easily. However, since the number of mobile stations is small, combining gain that may be obtained becomes small. Also, since a link or channel status (or quality) between the mobile station 10b and the base station 20 may not be good, a success rate of transmission may be lowered relatively.

In FIG. 3(a), the mobile station 10a that request cooperation transmits its data to the other mobile station 10b and also transmits the data to the base station 20. If the mobile station 10b transmits the data to the base station 20, the base station 20 may additionally obtain combining gain.

On the other hand, in FIG. 3(b), if the mobile station 10a its data to the other mobile station 10b, it does not transmit the data to the base station 20.

For another example, the mobile station 10a may request the mobile station 10b of cooperation due to the reason such as poor channel status or insufficient resource allocation, and the mobile station 10b may request another mobile station of cooperation. The another mobile station may request a separate another mobile station of request. In this case, one or more of the mobile stations may transmit the data of the mobile station 10a to the base station 20 in response to the cooperative request. In this case, the other mobile stations except for the cooperative request mobile station correspond to the cooperative join mobile stations, and the mobile station that joins in the cooperation and actually transmits data corresponds to the cooperative transmission mobile station.

Also, the cooperative request mobile station may transmit its data to the base station, and the cooperative transmission mobile station may transmit the data of the cooperative request mobile station to the base station 20.

FIG. 4 is a diagram illustrating a concept of a cooperative cluster of mobile stations to which an embodiment of the present invention may be applied.

The mobile stations may be divided into a non-cooperative terminal, a cooperation-capable terminal, a cooperative join terminal, a cooperative transmission terminal, a cooperation request terminal, etc. depending on their operations and functions. The non-cooperative terminal may be referred to as a single transmission terminal

Also, the cooperation-capable terminal may be referred to as a cooperative terminal candidate. The cooperative request terminal may be referred to as a cooperative entity terminal. The cooperative transmission terminal may be referred to a cooperative mobile station or a cooperated mobile station.

As described above, the cooperative join mobile station means the mobile station that joins in cooperative transmission but does not transmit data to the base station. At this time, the mobile station that grants the cooperative request may be referred to as a cooperative grant mobile station. The cooperative grant mobile station is a terminology that includes the cooperative transmission mobile station (or cooperative mobile station) or the cooperative join mobile station.

The cooperation-capable mobile station may be grouped into a virtual group called a cooperative cluster 10′ as shown in FIG. 4. In this case, the cooperative cluster 10′ may be expressed as client cooperation connection or mobile station pairing.

In more detail, as shown in FIG. 4(a), the cooperative cluster 10′ may include all the mobile stations capable of cooperation, or may include mobile stations capable of cooperation based on geometry information as shown in FIG. 4(b).

The cooperative cluster 10′ may be generated by the base station if the mobile station enters the base station (network entry), or may be generated by direct cooperation between the mobile stations.

If the cooperative cluster 10′ is generated by the base station, information on the cooperative cluster may be broadcasted periodically by the base station, or may be unicasted by a request of the mobile station.

If the mobile stations form the cooperative cluster 10′ by themselves, the information on the cooperative cluster may be unicasted or multicasted by the mobile stations or a random mobile station.

Meanwhile, in FIG. 4, in the cooperative transmission, the cooperative cluster is generated for the mobile stations only which belong to a cell of one base station.

### Wireless Communication Environment Based On Heterogeneous Networks

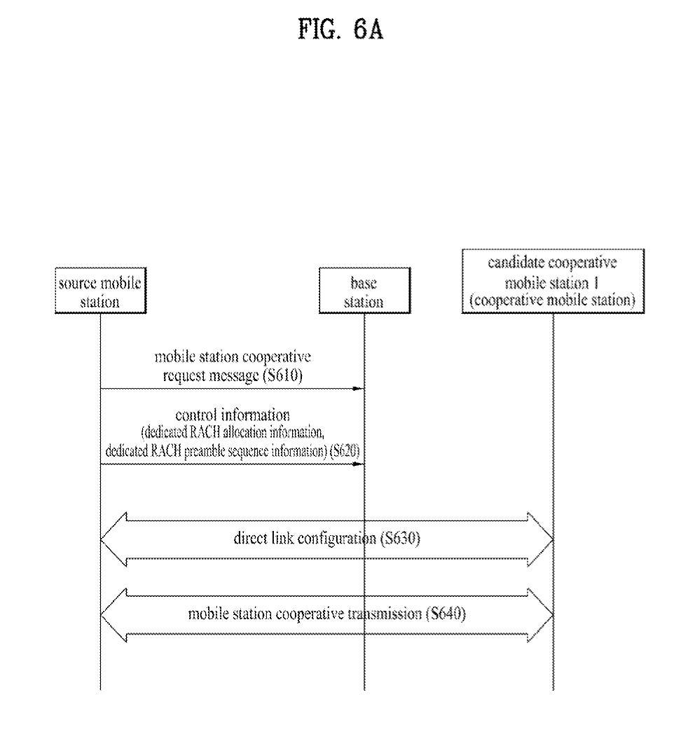

FIG. 5 is a diagram illustrating an example of a system that performs client cooperation (CC) between mobile stations in a wireless communication environment where two or more heterogeneous networks (multi-RAT), to which an embodiment of the present invention may be applied, exist.

In a mobile communication system, a mobile station may receive information from a base station through a downlink, and may also transmit information through an uplink. Information transmitted from or received by the mobile station may include data and various kinds of control information, and various physical channels exist depending on types or usage of the information transmitted from or received by the mobile station.

In the current communication environment, two or more heterogeneous networks may exist. For example, various heterogeneous networks such as a WiMAX network which is an example of the mobile communication system and a WiFi network may exist. The heterogeneous network means a network that uses a communication system different from that used by a specific network, and a heterogeneous mobile station means a mobile station which belongs to a heterogeneous network that uses a communication system different from that of the specific network.

For example, on the basis of the WiMAX network and the mobile station which belongs to the WiFi network, since the WiFi network uses a communication system different from that of the WiMAX network, it corresponds to a heterogeneous network. The mobile station which belongs to the WiFi network corresponds to the heterogeneous mobile station. By contrast, on the basis of the WiFi network, the WiMAX network may be the heterogeneous network, and the mobile station which belongs to the WiMAX network may be the heterogeneous network.

In the present invention, a multi-mode mobile station means a mobile station that supports use of two or more heterogeneous networks (or a plurality of RAT). WiFi means a short distance communication network (LAN) that allows ultra-speed Internet within a given distance of a place where an access point (AP) is provided, and uses a radio wave or infrared transmission mode and may be referred to as a wireless LAN.

In a wireless environment, the multi-mode mobile station may use a heterogeneous network which exists to support a heterogeneous mobile station in addition to a radio access technology (RAT) provided to efficiently transmit and receive a signal or improve throughput. The RAT is a type of a technology used for radio access. For example, the RAT includes GSM/EDGE Radio Access Network (GERAN), UMTS Terrestrial Radio Access Network (UTRAN), Evolved-UMTS Terrestrial Radio Access Network (E-UTRAN), WiMAX, LTE(-A), and WiFi. The GERAN, the UTRAN, the E-UTRAN, the WiMAX, and/or WiFi coexist.

At this time, the multi-mode mobile station that supports a plurality of RAT to use two or more heterogeneous networks may transmit and receive a signal without being restricted to a specific RAT by using another RAT that may provide the best service under the current status. The number of heterogeneous networks (a plurality of RATs) to which the multi-mode mobile station accesses to transmit and receive a signal may be two or more. Accordingly, the multi-mode mobile station may transmit and receive a signal to and from the base station, which uses RAT different from that of a serving base station, or the base stations, which use heterogeneous networks (heterogeneous RAT), respectively or through cooperation.

Referring to FIG. 5, in a wireless communication system 100, the mobile station may transmit and receive a signal by using two or more heterogeneous networks (or a plurality of RATs).

In FIG. 5, for example, the mobile station transmits and receives a signal by using a first network (for example, WiMAX network) and a second network (for example, WiFi network). In the wireless communication system, the first mobile station 10a and the second mobile station 10b are the multi-mode mobile stations that may use two or more heterogeneous networks, that is support multi-RAT.

In other words, as shown in FIG. 5, the first mobile station 10a and the second mobile station 10b support the WiMAX network corresponding to the heterogeneous networks and a multi-mode to transmit and receive a signal through the WiFi network.

At this time, a base station (BS) 20a of the first network (WiMAX network) may exist in the wireless communication system 100. In the wireless communication system, the first mobile station 10a and the second mobile station 10b, which support the multi-RAT, may transmit and receive a signal to and from the base station 20a through the first network (WiMAX).

Also, an access point (AP) 20b corresponding to the base station of the second network (WiFi network) may exist in the wireless communication system. In the wireless communication system, the first mobile station 10a and the second mobile station 10b, which support the multi-RAT, may transmit and receive a signal to and from each other through the second network (WiFi).

In other words, in the wireless communication system 100, the first mobile station 10a and the second mobile station 10b may perform communication through the access point 20b in accordance with a configuration of an infrastructure mode, or may perform direct communication with each other in accordance with a configuration of an Ad-hoc mode. Hereinafter, it is assumed that the first mobile station 10a and the second mobile station 10b may transmit and receive a signal to and from each other through the second network WiFi even without detailed mention of the access point 20b.

In this specification, it is assumed that client cooperative (CC) communication performed between the first mobile station 10a and the second mobile station 10b is for the second network (WiFi network) corresponding to a direct link between the mobile stations, which is different from the first network (WiMAX network) corresponding to a cellar network. As described above, although the WiFi network is disclosed in this specification as an example of the direct link between the mobile stations, the present invention is not limited to the WiFi network.

In the meantime, the first mobile station 10a and the second mobile station 10b are subjected to grouping or pairing to transmit and receive a signal to and from each other through the cooperative communication CC therebetween. Grouping or pairing between the first mobile station 10a and the second mobile station 10b may be performed in such a manner that any one of the mobile stations determines the other mobile station which will perform client cooperative communication and requests the base station 20a of cooperative communication, or may be performed in such a manner that the base station 20a indicates information of the mobile stations which will perform client cooperative communication.

Hereinafter, a method for configuring a link for direct communication between a first mobile station (hereinafter, referred to as ‘source mobile station’) requesting mobile station cooperation and a second mobile station (hereinafter, referred to as ‘cooperative mobile station’) granting mobile station cooperation in client cooperative communication suggested in this specification and a method for transmitting and receiving data will be described in more detail.

In this case, as described with reference to FIG. 5, the same communication system (for example, WiMAX, LTE(-A)) as that of the source mobile station and the cooperative mobile station with the base station or the other communication system (for example, WiFi) different from that of the source mobile station and the cooperative mobile station with the base station may be used for direct link communication between the source mobile station and the cooperative mobile station.

Also, in this specification, although the method for configuring a direct link between corresponding mobile stations on the basis of client cooperative communication will be described, it will be apparent that the same concept may be applied to configuration of a direct link for direct communication between mobile stations.

### Definition of Uplink Subframe For Direct Communication Between Mobile Stations

First of all, the base station configures an uplink (UL) subframe for performing direct link communication between the source mobile station and the cooperative mobile station to perform client cooperative (CC) transmission. In other words, the mobile stations, which perform cooperative transmission, perform direct link communication through a direct link UL subframe set from the base station.

In other words, if the base station (random cell) supports FDD, the source mobile station and the cooperative mobile station may directly transmit and receive data to and from each other through UL subframe of UL CC (Component Carrier).

Also, even if the base station supports TDD, direct link data transmission and reception between the source mobile station and the cooperative mobile station is performed through direct link UL subframe set by the base station.

For example, if mobile relaying type client cooperative transmission is performed, uplink data of the source mobile station are transmitted to the cooperative mobile station through UL resource of the direct link UL subframe.

Also, for downlink data to be transmitted from the base station to the source mobile station through the cooperative mobile station, when the cooperative mobile station transmits the downlink data to the source mobile station, the downlink data are transmitted through UL resource of the direct link UL subframe set by the base station.

Also, in the direct link UL subframe set by the base station, a timing relation between the direct link UL subframe from the source mobile station to the cooperative mobile station and the direct link UL subframe from the cooperative mobile station to the source mobile station will be required to be configured.

In this case, the direct link UL subframe used by the source mobile station to transmit a signal to the cooperative mobile station will be referred to as ‘first direct link UL subframe’, and the direct link UL subframe used by the cooperative mobile station to transmit a signal to the source mobile station will be referred to as ‘second direct link UL subframe’.

For example, if mobile relaying is used for client cooperative transmission and data transmission from the source mobile station to the cooperative mobile station is performed, a feedback link for HARQ feedback from the cooperative mobile station to the source mobile station is required. In this case, if a random UL subframe #k is implicitly set as a first direct link UL subframe in the FDD system, UL subframe #k+n (e.g. n=4, 5, 6, . . . ) may be set as the second direct link UL subframe, whereby HARQ ACK/NACK feedback may be performed through the UL subframe #k+n, or other control information and data information may be transmitted from the cooperative mobile station to the source mobile station.

However, in case of the TDD system, if a direct link between the source mobile station and the cooperative mobile station is supported by the direct link UL subframe only, which is set by the base station, the feedback timing may be performed in a unit of radio frame.

In other words, if the UL subframe #k of the random radio frame #N is set as the first direct link UL subframe, the UL subframe #k of the same index of next radio frame #N+1 may implicitly be set as the second direct link UL subframe.

Alternatively, the first direct link UL subframe from the source mobile station to the cooperative mobile station and the second direct link UL subframe from the cooperative mobile station to the source mobile station may be set independently through explicit higher layer signaling.

### Dedicated RACH Resource Allocation For Link Configuration Between Mobile Stations That Perform Cooperative Transmission

Hereinafter, a method for allocating a dedicated RACH resource for performing synchronization and channel measurement between the source mobile station and the cooperative mobile station will be described.

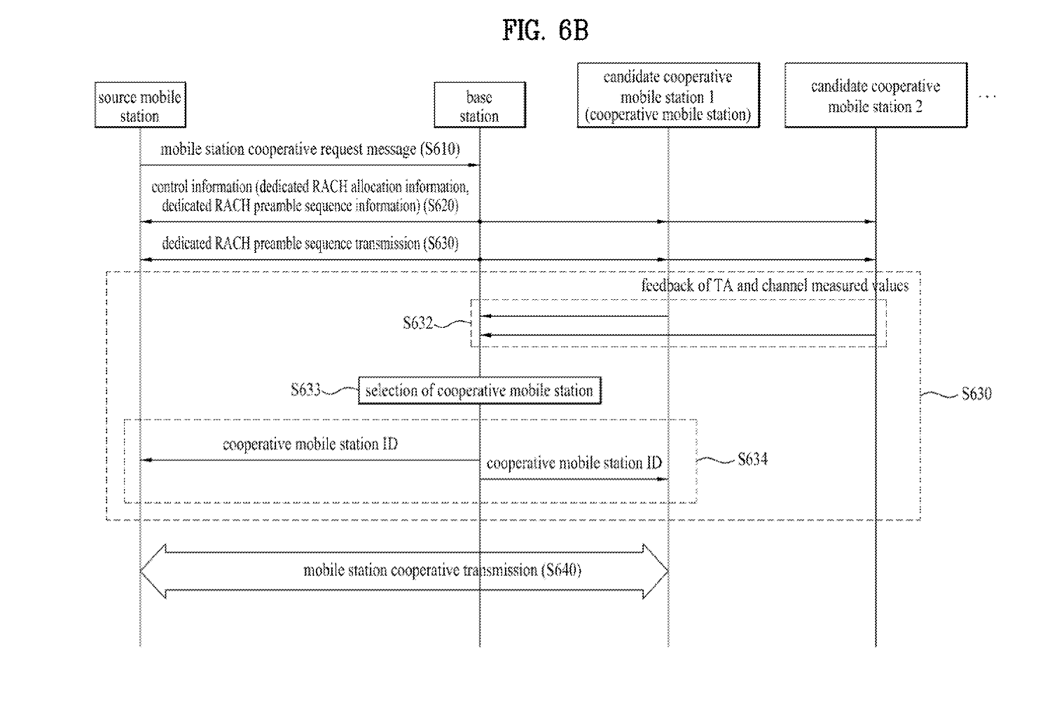

FIGS. 6(a) and 6(b) are flow charts illustrating a method for allocating a dedicated random access channel resource for direct link communication between mobile stations according to one embodiment of the present invention.

Referring to FIG. 6(a), the source mobile station transmits a client cooperative communication (or transmission) request message to the base station to perform client cooperative transmission (S610). The mobile station requests the base station of client cooperation for the purpose of throughput enhancement or power consumption reduction, or for the purpose of direct communication without through the base station. In this case, the cooperative communication request message may be transmitted through a PUSCH in the form of higher layer signaling, that is, RRC signaling, or may be transmitted through a PUCCH (Scheduling Request or CQI/CSI feedback channel, etc.).

Also, in case of a 802.16 system, the cooperative communication request message may be transmitted to the base station through a data channel in the form of MAC management message, or may be transmitted to the base station through a quick access message of a BR channel.

Afterwards, the base station may transmit dedicated RACH resource allocation information for direct link communication between the source mobile station and the cooperative mobile station to the source mobile station (S620). In other words, the base station transmits dedicated random access channel (RACH) resource allocation information for direct communication with the cooperative mobile station to the source mobile station, which has requested the cooperative communication. Also, the base station transmits dedicated RACH preamble sequence information to the source mobile station.

In this case, the dedicated RACH preamble sequence information means RACH root sequence information and cyclic shift information.

Afterwards, the source mobile station transmits the dedicated RACH preamble sequence to the base station through the dedicated RACH allocated from the base station, thereby configuring a direct link for direct link communication with the cooperative mobile station (S630).

In this case, the source mobile station may transmit the dedicated RACH preamble sequence to candidate cooperative mobile stations through a PRACH previously set by the base station in accordance with a previously set preamble format.

At this time, the base station may transmit timing information of the PRACH to the source mobile station explicitly or implicitly together with the dedicated RACH preamble sequence allocation information. In this case, the timing information of the PRACH means the timing information as to when the dedicated RACH preamble sequence will be transmitted through the PRACH.

Also, as the method for transmitting timing information explicitly, the timing information of the PRACH may be represented as a subframe timing offset value, or an absolute timing value may directly be transmitted. In this case, the subframe timing offset value means a subframe offset value from a subframe to which the dedicated RACH preamble sequence is allocated, to a subframe of a PRACH through which the dedicated RACH preamble sequence should be transmitted to the candidate cooperative mobile stations.

Also, the absolute timing value may include a subframe index value having a PRACH through which the dedicated RACH preamble sequence should be transmitted to the candidate cooperative mobile stations, and may additionally include a radio frame index value if necessary.

Also, the base station may also transmit expiration time information of the corresponding dedicated RACH preamble sequence explicitly, or may fix the expiration time information to a random m subframe implicitly.

In this case, the source mobile station may repeatedly transmit the dedicated RACH preamble sequence to the candidate cooperative mobile stations through all the PRACHs within the corresponding expiration time.

As another method, the source mobile station may transmit the dedicated RACH preamble sequence to the candidate cooperative mobile stations through the PUSCH not the PRACH. In this case, the base station may allocate the PUSCH resource to the source mobile station and notify the candidate cooperative mobile stations of the allocated PUSCH resource allocation information.

In other words, the base station transmits subframe timing information for transmitting the dedicated RACH preamble sequence and PRB (Physical Resource Block) allocation information for transmitting the dedicated RACH preamble sequence for the subframe to the source mobile station.

In this case, the subframe timing information for transmitting the dedicated RACH preamble sequence may be transmitted to the source mobile station explicitly in the same manner as timing information of the transmission method through the PRACH, or may be fixed implicitly. In this case, the same method as the transmission method through the PRACH may be used for the explicit transmission method and the implicit fixing method.

Generally, 6 PRBs are required to transmit the RACH preamble sequence. If the base station signals one PRB index value to the source mobile station, the source mobile station may transmit the dedicated RACH preamble sequence to the candidate cooperative mobile stations through six continuous PRBs on the basis of the PRB index value used as the offset value.

Also, the base station may transmit an interleaving size to the source mobile station together with the PRB index value. In this case, the interleaving size is an interleaved value of the dedicated RACH preamble sequence, which is intended to be transmitted to the candidate cooperative mobile stations if the source mobile station transmits the dedicated RACH preamble sequence, wherein interleaving may be performed in a unit of PRB. Also, the interleaving size is expressed as the number of interleaved PRBs.

In other words, the source mobile station may perform interleaving as much as the interleaving size on the basis of the reference PRB index, that is, may transmit the dedicated RACH preamble sequence to the candidate cooperative mobile stations in the form of a distributed type. The dedicated RACH preamble sequence may be transmitted by hopping on the border of a slot within the corresponding subframe, or may be subjected to hopping per subframe through a plurality of subframes and then may be transmitted through a full band.

For example, if a given UL band includes 48 PRBs of #0˜#47, the dedicated RACH preamble may be transmitted once through a full band over a total of 8 UL frames per sub-band that includes 6 PRBs through one UL subframe.

In this case, the base station may transmit configuration information on the dedicated RACH preamble sequence to the source mobile station through higher layer signaling or the PDCCH as described above. In this case, the higher layer signaling may be RRC signaling.

Also, in case of the 802.16 system, the base station may transmit the configuration information on the dedicated RACH preamble sequence to the source mobile station through a data channel or A-MAP in the form of MAC management message.

Hereinafter, the step S630, that is, the step of configuring the direct link of the source mobile station with the cooperative mobile station will be described in more detail with reference to FIG. 6(b).

The base station also transmits the configuration information on the dedicated RACH preamble sequence to the candidate cooperative mobile stations (S621).

In this case, the base station may multi-cast the same signal to the candidate cooperative mobile stations through group-specific higher layer signaling, or may unicast the same signal to the candidate cooperative mobile stations through UE-specific higher layer signaling.

In this case, if the base station unicasts the configuration information on the RACH preamble sequence to the respective candidate mobile stations, it may transmit the corresponding information through an individual PDCCH CRC masked with each candidate cooperative mobile station ID.

Also, if the base station multicasts the configuration information on the RACH preamble sequence to the respective candidate mobile stations, it may allocate group ID for the candidate cooperative mobile stations and perform CRC masking through corresponding group ID, whereby all the candidate cooperative mobile stations may receive the same PDCCH that includes the RACH preamble sequence configuration information.

Accordingly, after receiving the dedicated RACH preamble sequence from the corresponding source mobile station (S631), the candidate cooperative mobile stations feeds a timing advance (TA) value of a direct link with the source mobile station and a channel measured value back to the base station (S632).

In this case, the TA value is to advance the transmission timing of the mobile station to compensate for transmission delay of the mobile station, which occurs due to movement and other reasons, and means a value transmitted from the base station to the mobile station.

Also, the TA value is set on the basis of UL subframe timing of the cooperative mobile station. Accordingly, if the source mobile station performs direct communication with the cooperative mobile station, it transmits data to the cooperative mobile station on the basis of the TA value.

In this case, the last symbol of the direct link subframe may be used RTG/TTG time of the cooperative mobile station. In this case, the source mobile station may puncture the corresponding last symbol or perform rate matching by using the other symbols except for the last symbol.

Also, the channel measured value if the candidate cooperative mobile stations may be a wide band CQI feedback value for a full band, or the channel measured value per sub-band may be fed back to the base station.

Also, the candidate cooperative mobile stations may feed the channel measured value for the sub-band back to the base station together with indication information indicating the best sub-band only if the corresponding value exceeds a channel measured value of the sub-band indicated by the indication information or a specific threshold value.

In this case, the channel measured value is transmitted from each of the candidate cooperative mobile stations to the base station through higher layer signaling. The base station may transmit UL grant which is uplink resource allocation information for transmission of the feedback value to the candidate cooperative mobile stations together with the configuration information on the dedicated RACH preamble sequence.

In other words, the base station may together transmit the configuration information on the dedicated RACH preamble sequence and UL resource allocation information for feeding back the TA value and the channel measured value.

Also, the base station may transmit the UL grant to the candidate cooperative mobile station through the PDCCH after N (=0, 1, 2, 3, . . . ) subframe on the basis of the dedicated RACH preamble sequence transmission timing.

Afterwards, the base station sets the most suitable cooperative mobile station on the basis of the feedback value of the TA value and the channel measured result received from the candidate cooperative mobile stations (S633), and notifies the source mobile station and the set cooperative mobile station of the set cooperative mobile station (S634).

To this end, the base station may set the TA value fed back from the candidate cooperative mobile stations to the source mobile station and group ID newly defined for cooperative communication and notify the source mobile station of the TA value and the set group ID, or may notify the source mobile station of cooperative mobile station ID.

Also, the base station transmits a confirm message indicating that the cooperative mobile station has been set, to the cooperative mobile station set as the cooperative mobile station of the source mobile station, and may notify the cooperative mobile station of group ID for cooperative communication or source mobile station ID together with the confirm message.

Although one of the candidate cooperative mobile stations has been set by the base station, the cooperative mobile station may be set by the source mobile station. In this case, the procedure of selecting one of the candidate cooperative mobile station through the source mobile station is similar to the procedure of setting the cooperative mobile station through the base station.

Afterwards, the source mobile station performs mobile station cooperative transmission by transmitting and receiving data through direct link communication with the set cooperative mobile station (S640).

Subframe structure for direct link communication between cooperative mobile stations

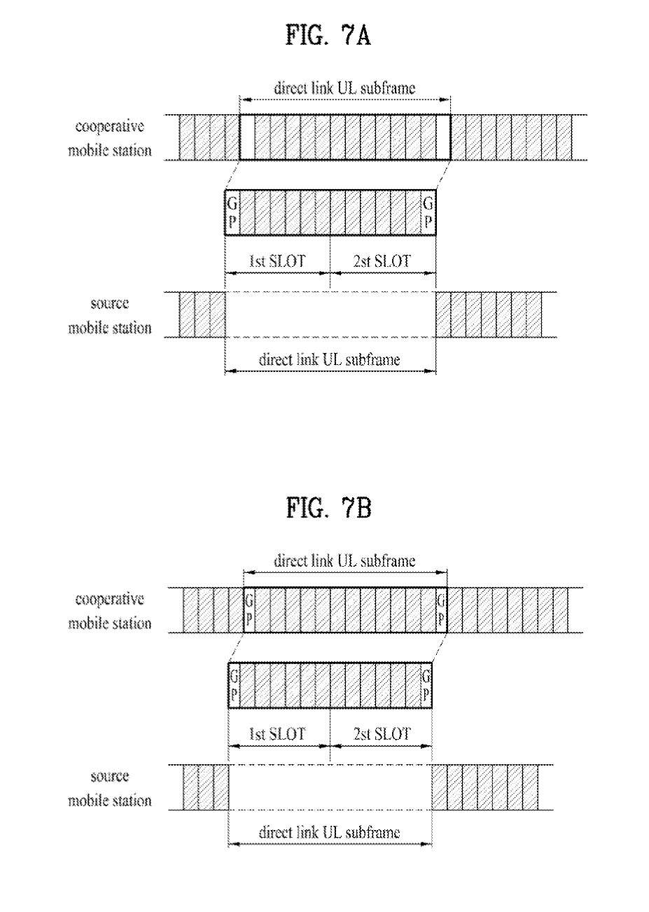

FIGS. 7(a) and 7(b) are diagrams illustrating a subframe structure for direct link communication between cooperative mobile stations according to one embodiment of the present invention.

If direct link communication between the source mobile station and the cooperative mobile station is performed through direct link UL subframe used for cooperative transmission, a symbol structure that may be used for the UL subframe may be varied depending on a TA value of a direct link based on the distance between the two mobile stations and a TA value which is previously set for uplink transmission from each of the source mobile station and the cooperative mobile station to the base station.

Also, since the cooperative mobile station should be operated in a receiving mode to receive data from the source mobile station in case of UL subframe used for a direct link, a transition gap of transmission and reception modes may be required depending on a relation with a neighboring UL subframe (or neighboring DL subframe in case of a TDD system).

In particular, if the source mobile station transmits a signal at its UL subframe timing in accordance with a relation between UL subframe timing set at the source mobile station in accordance with the distance between each source mobile station and the base station and UL subframe timing set at the cooperative mobile station in accordance with the distance between the cooperative mobile station and the base station, signal transmission delay timing based on the distance between the source mobile station and the cooperative mobile station may be included in a cyclic prefix (CP) length of OFDMA (or SC-FDMA) symbol.

In this case, a transition gap may be used by the cooperative mobile station for one symbol of a front subframe of a direct link UL subframe and one subframe of a rear subframe of the direct link UL subframe in accordance with setting of the front subframe and the rear subframe which are neighboring frames of the corresponding direct link UL subframe.

For example, in case of the FDD system, if a front subframe of UL subframe set for direct link reception from the source mobile station is used by the cooperative mobile station for UL communication with the base station, one symbol at the front of the corresponding direct link UL subframe may be punctured to be used as a transition gap.

Also, if a rear subframe of UL subframe set for direct link reception from the source mobile station is used by the cooperative mobile station for UL communication with the base station, one symbol at the rear of the corresponding direct link UL subframe may be punctured to be used as a transition gap.

In case of the TDD system, in addition to the case where the UL subframe with the base station is used at the front and rear of the corresponding direct link UL subframe in the same manner as the FDD system, DL subframe may be used.

In case of the TDD system, if the front subframe of the direct link UL subframe used by the cooperative mobile station is DL subframe, the transition gap may not be required for the direct link UL subframe.

Also, in the FDD and TDD structures, even though the front and rear subframes of the corresponding direct link UL subframe are UL subframes, if the corresponding UL subframes are not used for uplink transmission with the base station, no transition gap may be required for the direct link UL subframe.

In this case, the last symbol of the UL subframe directly before the direct link UL subframe of the cooperative mobile station may be punctured to be used as a transition gap, and a direct link signal of the source mobile station may be received in the order of the first symbol of the direct link UL subframe.

Also, even though the UL subframe with the base station exists at the front and rear of the corresponding direct link UL subframe in case of the cooperative mobile station, instead of two symbols based on one symbol for each of the front and rear of the direct link UL subframe, one symbol based on half symbol for each of the front and rear of the direct link UL subframe may be used as the transition gap.

In other words, K-1 number of symbols of a total of K number of symbols constituting the direct UL subframe may be used for direct link communication.

FIG. 7(a) illustrates a case where two symbols based on one symbol for each of the front and rear of the direct link UL subframe are used as transition gaps in the 3GPP LTE/LTE-A FDD system, and FIG. 7(b) illustrates a case where one symbol based on half symbol for each of the front and rear of the direct link UL subframe is used as a transition gap.

In addition to the transition gap illustrated in FIGS. 7(a) and 7(b), the number of symbols used for the direct link UL subframe may be controlled variably depending on the other factors.

In other words, if TA is required depending on the distance between the cooperative mobile station and the source mobile station, the number of symbols that may be used (or received) by the cooperative mobile station for the direct link UL subframe may be varied depending on the corresponding TA value.

As described above, the direct link UL subframe structure may be varied depending on configuration of the transition gap and the TA value of the direct link. In other words, among K number of symbols used for the direct link UL subframe, N(=0, 1, 2, . . . ) number of symbols at the front of the direct link UL subframe and M(=0, 1, 2, . . . ) number of symbols at the rear of the direct link UL subframe may be set to a guard time.

In this case, the N value and the M value may be set semi-statically and may be transmitted to each of the cooperative mobile station and the source mobile station by higher layer signaling, or may be set dynamically together with direct link resource allocation information through a downlink control channel such as PDCCH and A-MAP and then may be transmitted to each mobile station.

Alternatively, the base station may set the N value and the M value implicitly to one of the aforementioned methods in accordance with the subframes (that is, DL subframe or UL subframe) at the front and rear of the UL direct link subframe.

The method for measuring TA and channel in case of data transmission from the source mobile station to the cooperative mobile station and the structure of the direct link UL subframe used in this case have been described as above. On the other hand, even in case of data transmission from the cooperative mobile station to the source mobile station, the method for measuring channel and TA of the direct link UL subframe and the method for configuring a direct link UL subframe structure may be used in the same manner.

### HARQ Feedback Transmission Method In Direction Communication

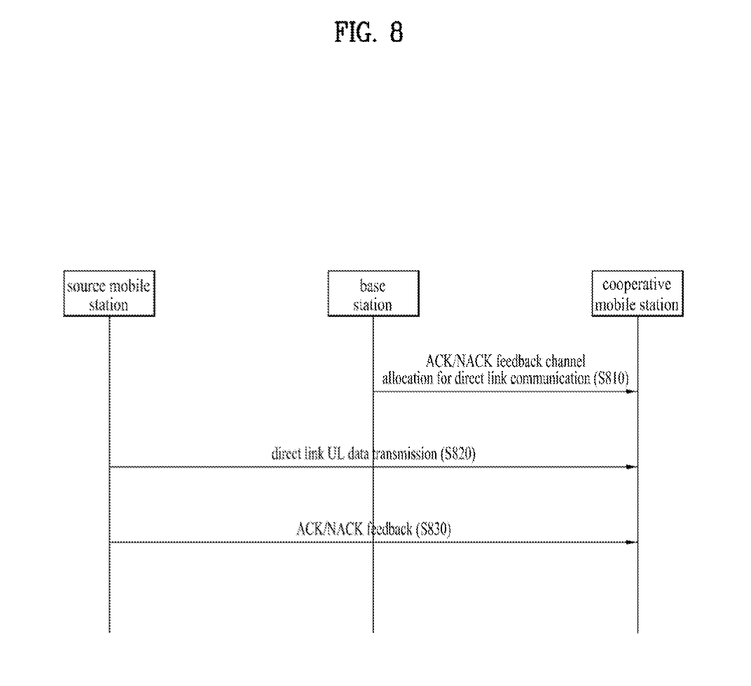

FIG. 8 is a flow chart illustrating a HARQ feedback procedure of a cooperative mobile station in direct link communication for mobile station cooperative transmission according to one embodiment of the present invention.

As illustrated in FIG. 8, the base station transmits feedback channel allocation information for ACK/NACK feedback for data received by the cooperative mobile station from the source mobile station through a first direct link UL subframe to the cooperative mobile station (S810).

Afterwards, if the source mobile station transmits data to the cooperative mobile station through the first direct link UL subframe (S820), the cooperative mobile station feeds ACK/NACK for data transmission of the source mobile station back to the source mobile station through a feedback channel allocated from the base station (S830). In this case, the feedback channel allocated from the base station may be a PUCCH or a data channel.

First of all, a PUCCH structure for uplink ACK/NACK feedback to the existing base station may be used for ACK/NACK feedback of the cooperative mobile station. In other words, if the cooperative mobile station receives data from the source mobile station through the first direct link UL subframe, it may transmit ACK/NACK feedback signal to the source mobile station in the form of PUCCH through the UL subframe for feedback of the cooperative mobile station as described above.

In this case, the PUCCH resource may be transmitted to each of the source mobile station and the cooperative mobile station through higher layer signaling together with the configuration information on the direct link UL subframe.

However, as described above, if the guard time is included in the direct link UL subframe, a length of a PUCCH feedback sequence may be varied in accordance with the direct link UL subframe structure, or a punctured format may be used.

As another example, the cooperative mobile station may transmit the HARQ feedback for the data transmitted from the source mobile station to the source mobile station through the data channel.

In this case, a resource of the data channel may be transmitted to each of the source mobile station and the cooperative mobile station through higher layer signaling, or may dynamically be allocated to each of the source mobile station and cooperative mobile station through a downlink control channel.

The aforementioned embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment.

In this specification, the embodiments of the present invention have been described based on data transmission and reception between a base station and a mobile station. In this case, the base station means a terminal node of a network, which performs direct communication with the mobile station. A specific operation which has been described as being performed by the base station may be performed by an upper node of the base station as the case may be.

Those skilled in the art will appreciate that the present invention may be carried out in other specific ways than those set forth herein without departing from the spirit and essential characteristics of the present invention. It is also obvious to those skilled in the art that claims that are not explicitly cited in each other in the appended claims may be presented in combination as an embodiment of the present invention or included as a new claim by a subsequent amendment after the application is filed. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

1. A method for performing mobile station cooperative transmission through direct link communication between a source mobile station requesting mobile station cooperation and a cooperative mobile station performing mobile station cooperative transmission, the method comprising the steps of:
allowing the source mobile station to transmit a mobile station cooperation request message for requesting the mobile station cooperative transmission to a base station;
allowing the base station to transmit control information for configuring a direct link between the source mobile station and the cooperative mobile station to the source mobile station; and
allowing the source mobile station to configure a direct communication link with the cooperative mobile station on the basis of the received control information,
wherein the control information includes dedicated random access channel (RACH) allocation information for synchronization and channel measurement between the source mobile station and the cooperative mobile station, and dedicated random access channel (RACH) preamble sequence information.

2. The method according to claim 1, wherein the step of configuring a direct communication link includes the steps of:
allowing the base station to transmit the dedicated RACH preamble sequence information, which is transmitted to the source mobile station, to at least one candidate cooperative mobile station;
allowing the source mobile station to transmit the dedicated RACH preamble sequence information to the at least one candidate cooperative mobile station through a dedicated random access channel allocated from the base station; and
allowing the at least one candidate cooperative mobile station to feed a timing advance (TA) value and a channel measured value for a direct link with the source mobile station back to the base station on the basis of the dedicated random access channel preamble sequence information received from the source mobile station.

3. The method according to claim 2, wherein the at least one candidate cooperative mobile station feeds a channel measured value for a full band, per sub-band, or for a specific sub-band back to the base station, if the channel measured value is greater than a threshold value which is previously defined.

4. The method according to claim 2, further comprising the steps of:
allowing the base station to set at least one cooperative mobile station for performing cooperative transmission with the source mobile station on the basis of the feedback channel measured value and the timing advance value of the at least one candidate cooperative mobile station; and
allowing the base station to transmit information on the set cooperative mobile station to the source mobile station and the set cooperative mobile station.

5. The method according to claim 1, further comprising the step of allowing the source mobile station to transmit and receive data to and from the cooperative mobile station through an uplink (UL) subframe defined for direct link communication between the source mobile station and the cooperative mobile station.

6. The method according to claim 5, wherein the step of allowing the source mobile station to transmit and receive data to and from the cooperative mobile station includes transmitting data to the cooperative mobile station through a first direct link UL subframe, and allowing the cooperative mobile station to transmit ACK/NACK for the data received from the source mobile station, to the source mobile station through a second direct link UL subframe.

7. The method according to claim 6, further comprising the step of allowing the base station to transmit information indicating timing relation between the first direct link UL subframe and the second direct link UL subframe to at least one of the source mobile station and the cooperative mobile station.

8. The method according to claim 5, wherein at least one symbol at the front and/or the rear of the uplink subframe is used as a transition gap of a transmission and reception mode.

9. The method according to claim 8, wherein the transition gap is set variably depending on a timing advance (TA) value based on a distance between the source mobile station and the cooperative mobile station.

10. The method according to claim 1, wherein the control information further includes timing information on transmission timing of the dedicated RACH preamble sequence, the timing information being expressed as a subframe offset value or a subframe index value.

11. The method according to claim 2, further comprising the step of allowing the at least one candidate cooperative mobile station to receive uplink (UL) grant for feeding back the channel measured value and the timing advance (TA) value from the base station.

12. The method according to claim 11, wherein the UL grant is received from the base station after a predetermined subframe on the basis of the dedicated RACH preamble sequence transmission timing.

13. A mobile station for performing mobile station cooperative transmission through direct link communication with a source mobile station in a wireless access system, the mobile station comprising:
a radio frequency (RF) unit for externally transmitting and receiving a radio signal; and
a controller connected with the RF unit,
wherein the controller controls the RF unit to transmit a mobile station cooperation request message for requesting the mobile station cooperative transmission to a base station, controls the RF unit to receive control information for configuring a direct link with the cooperative mobile station from the base station, and controls the RF unit to configure the direct communication link with the cooperative mobile station on the basis of the received control information, and
the control information includes dedicated random access channel (RACH) allocation information for synchronization and channel measurement between the source mobile station and the cooperative mobile station, and dedicated random access channel (RACH) preamble sequence information.
